(19) United States
(12) Patent Application Publication
(10) Pub. No.: US 2015/0258560 A1
(43) Pub. Date: Sep. 17, 2015

(54) Scent Based Workout Mechanism

(71) Applicant: ICON Health & Fitness, Inc., Logan, UT (US)

(72) Inventors: Darren C. Ashby, Richmond, UT (US); Scott R. Watterson, Logan, UT (US)

(21) Appl. No.: 14/641,978

(22) Filed: Mar. 9, 2015

Related U.S. Application Data
(60) Provisional application No. 61/951,906, filed on Mar. 12, 2014.

(51) Int. Cl. B05B 12/02

(52) U.S. Cl. CPC B05B 12/02

(57) ABSTRACT

A physiological control system includes at least one scent cartridge that selectively releases a volatile to cause a predetermined physiological effect on a user in response to a command from a processor. The processor is in communication with memory that contains programmed instructions to determine an effect time associated with a user workout to cause the predetermined physiological effect. The processor may send the release command to the scent cartridge based on the effect time.

### RELATED APPLICATIONS

This application claims priority to provisional Patent Application No. 61/951,906 titled “Scent Based Workout Mechanism” filed Mar. 12, 2014.

### BACKGROUND

While there are numerous exercise activities that one may participate in, exercise may be broadly broken into the categories of aerobic exercise and anaerobic exercise. Aerobic exercise generally refers to activities that substantially increase the heart rate and respiration of the exerciser for an extended period of time. This type of exercise is generally directed to enhancing cardiovascular performance. Such exercise usually includes low or moderate resistance to the movement of the individual. For example, aerobic exercise includes activities such as walking, running, jogging, swimming or bicycling for extended distances and extended periods of time.

Anaerobic exercise generally refers to exercise that strengthens skeletal muscles and usually involves the flexing or contraction of targeted muscles through significant exertion during a relatively short period of time and/or through a relatively small number of repetitions. For example, anaerobic exercise includes activities such as weight training, push-ups, sit-ups, pull-ups, or a series of short sprints.

Part of a person's ability to work out depends on the person's energy level and general mental state. For example, a person may perform at a level beneath his or her abilities when the person is dehydrated, has poor nutrition, has an inadequate calorie intake, or has had an inadequate amount of rest. Each of these conditions induces a physiological effect on the person.

One type of exercise system is disclosed in U.S. Pat. No. 8,038,577 issued to Tim McIntosh. In this reference, an interactive exercise management system is used for improving a workout environment for a specific user or group of users, tracking exercise information, and providing future workout information. The system, and method of using the system, allows for a specific user or group of users to control their workout environmental conditions. The conditions that may be controlled by the user include, but are not limited to, sight, sound, smell and climate. Another type of exercise system is described in U.S. Patent Publication No. 2007/0123390 issued to Christopher Mathis. Both of these references are herein incorporated by reference for all that they disclose.

### SUMMARY

In a preferred embodiment of the invention, a physiological control system includes at least one scent cartridge that selectively releases a volatile to cause a predetermined physiological effect on a user in response to a command from a processor. The processor is in communication with memory that contains programmed instructions to determine an effect time associated with a user workout to cause the predetermined physiological effect. The processor may send the release command to the scent cartridge based on the effect time.

In one aspect of the invention, a physiological control system includes at least one scent cartridge that selectively releases a volatile that exhibits a characteristic that causes a predetermined physiological effect on a user in response to a release command from a processor.

In one aspect of the invention, the processor being in communication with memory that contains programmed instructions to cause the processor to determine an effect time associated with a user workout to cause the predetermined physiological effect.

In one aspect of the invention, the processor sends the release command to the at least one scent cartridge based on the effect time.

In one aspect of the invention, the memory further contains programmed instruction to determine a release time prior to the effect time that allows the volatile to diffuse within predetermined space prior to the effect time.

In one aspect of the invention, the processor is in communication with an exercise machine.

In one aspect of the invention, the processor is programmed to obtain operating parameters of the exercise machine to determine the effect time.

In one aspect of the invention, the processor is programmed to determine the effect time based at least in part on a pre-programmed time.

In one aspect of the invention, the processor is programmed to determine the effect time based at least in part on historical behavioral data of the user.

In one aspect of the invention, the processor is programmed to determine the effect time based at least in part on a direct measurement of a physiological parameter of the user.

In one aspect of the invention, the physiological parameter is a heart rate.

In one aspect of the invention, the physiological parameter is a lactic acid build up amount.

In one aspect of the invention, the physiological parameter is a temperature.

In one aspect of the invention, the physiological parameter is a stress level.

In one aspect of the invention, the effect time is a predetermined end time of a workout.

In one aspect of the invention, the effect time is a predetermined initiation time of a workout.

In one aspect of the invention, the predetermined physiological effect includes inducing a heightened response in the user.

In one aspect of the invention, the predetermined physiological effect includes inducing a relaxing response in the user.

In one aspect of the invention, at least one scent cartridge is attached to an exercise machine.

In one aspect of the invention, a physiological control system may include at least one scent cartridge that selectively releases a volatile that exhibits a characteristic that causes a predetermined physiological effect on a user in response to a release command from a processor.

In one aspect of the invention, the processor being in communication with memory that contains programmed instructions to determine an effect time associated with a user workout to cause the predetermined physiological effect.

In one aspect of the invention, the processor is in communication with an exercise machine and is programmed to obtain operating parameters of the exercise machine to determine the effect time.

In one aspect of the invention, the processor sends the release command to the at least one scent cartridge based on the effect time.

In one aspect of the invention, may further include that the processor is in communication with an exercise machine and is programmed to obtain operating parameters of the exercise machine to determine the effect time.

In one aspect of the invention, may further include that the predetermined physiological effect includes inducing a heightened response or a relaxing response in the user.

In one aspect of the invention, may further include that the processor is programmed to determine the effect time based at least in part on a direct measurement of a physiological parameter of the user.

In one aspect of the invention, a physiological control system may include at least one scent cartridge that selective releases a volatile into a space with an exercise machine in response to a command from a processor, the volatile exhibiting a characteristics that causes a predetermined physiological effect on a user.

In one aspect of the invention, the processor being in communication with memory that contains programmed instructions to cause the processor to determine an effect time associated with a user workout to cause the predetermined physiological effect where the processor is programmed to determine the effect time based at least in part on a direct measurement of a physiological parameter of the user.

In one aspect of the invention, the processor is in communication with an exercise machine and is programmed to obtain operating parameters of the exercise machine to determine the effect time.

In one aspect of the invention, the predetermined physiological effect includes inducing a heightened response or a relaxing response in the user.

In one aspect of the invention, the processor sends the release command to the at least one scent cartridge based on the effect time.

Any of the aspects of the invention detailed above may be combined with any other aspect of the invention detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of an exercise machine releasing a volatile during a workout in accordance with the present disclosure.

FIG. 2 illustrates a top view of an example of a scent diffuser in accordance with the present disclosure.

FIG. 3 illustrates a side view of the scent diffuser of FIG. 2.

FIG. 4 illustrates a block diagram of an example of a releasing system in accordance with the present disclosure.

FIG. 5 illustrates a perspective view of an example of an exercise machine with a scent diffuser in accordance with the present disclosure.

FIG. 6 illustrates a block diagram view of an example of physiological control system in accordance with the present disclosure.

Throughout the drawings, identical reference numbers designate similar, but not necessarily identical, elements.

### DETAILED DESCRIPTION

There are a number of smell induced physiological effects that can impact a user's workout. For example, scents like orange, cedar, lavender, vanilla, apple, jasmine, lemon, cucumber, and others have been found to cause people to relax and/or reduce stress levels. Peppermint, mint, cinnamon, and others may cause a person to be more aggressive when they drive or perform other types of activities. However, not all smells evoke the same response in each person. As a result, what may cause one person to relax may be ineffective in assisting another person to relax.

The principles described in the present disclosure include a physiological control system with at least one scent cartridge that contains a volatile with a scent to cause a predetermined physiological effect on a user. As used herein, the term volatile shall be interpreted broadly to include any substance that is easily evaporated or otherwise transformed to, or maintained as, a vapor. A processor is in communication with memory that contains programmed instructions to determine an effect time associated with a user workout to cause the predetermined physiological effect at a desired time of the overall workout. A release mechanism is arranged to release the volatile into a space associated with the workout.

In some examples, the volatile is released into the space where a user plans to perform a workout, and the effect time is a time associated with the workout. For example, the effect time may be the initiation of a workout, and the processor causes the volatile to be released into the space at a time before the effect time so that the volatile has spread throughout the space and is ready for the user to inhale at the beginning of his or her workout. This can enable the volatile to have a predetermined physiological effect on the user from the beginning of his or her workout. In one example, the physiological effect is a heightened response that provides the user an increased ability to execute his or her workout. In such an example, the user maybe enable to do more during his or her workout. In such examples, the volatile may include a spearmint scent, a peppermint scent, another type of mint scent, a cinnamon scent, another type of scent, or combinations thereof. The heightened response induced by the volatile's scent may include increasing the user's heart rate, causing or increasing a hormone release, boosting mood, improving blood pressure, improving respiratory function, decreasing exhaustion, increasing energy, inducing psychological effects, causing other physiological effects, or combinations thereof.

In other examples, the effect time is at the end or near the end of the workout, and the volatile is to have the physiological effect of causing the user to relax. By relaxing the user at the end of the workout, the user may experience a diminished lactic acid build up, a reduced stress level, a quicker heart rate drop, a shorter recovery period, other types of physiological effects, or combinations thereof. In such examples, the volatile may include an orange scent, a cedar scent, a lavender scent, a vanilla scent, an apple scent, a jasmine scent, a lemon scent, a cucumber scent, another type of scent, or combinations thereof.

With reference to the present disclosure, the term “heighten” generally refers to those attributes that enhance the effectiveness of one's workout. For example, a heightened response may include an increased amount of energy, an improved heart rate, an improved respiratory function, a hormone release, an increased hormone release, decreased exhaustion, improved blood pressure, improved psychological effects, other physiological effects that can enhance a user's workout, or combinations thereof.

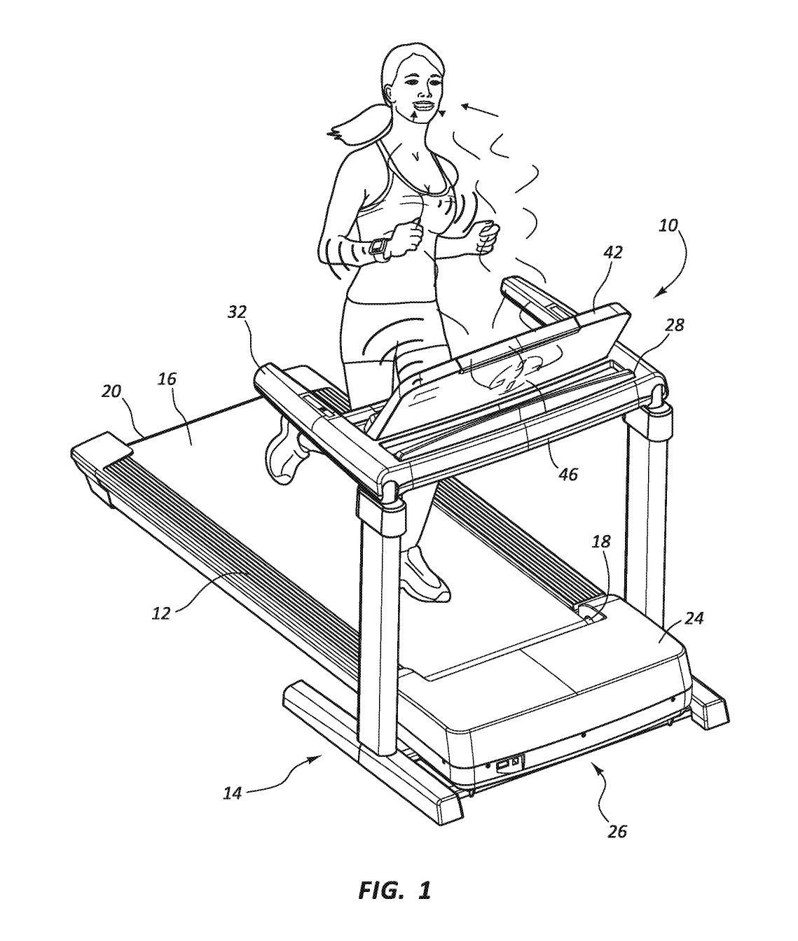

Particularly, with reference to the figures, FIG. 1 depicts an exercise machine 10, such as a treadmill. The exercise machine 10 includes a running deck 12 that can support the weight of a user where the running deck 12 is attached to a frame 14. The running deck 12 incorporates a conveyor belt 16 that extends from a first pulley 18 to a second pulley (not shown) at location 20. The underside of the conveyor belt's mid-section is supported by a low friction surface that allows the conveyor belt's underside to move without creating significant drag. The conveyor belt 16 is moved by a motor that is connected to the first pulley 18 and is disposed within a housing 24 formed in a front portion 26 of the running deck 12. As the conveyor belt 16 moves, a user positioned on the conveyor belt 16 can walk or run in place by keeping up with the conveyor belt's speed.

A platform 28 is also supported by the frame 14. In the example of FIG. 1, a support member positions a set of hand holds 32 near the platform 28 such that a user can support himself or herself during exercise. The support member 30 is attached to a top end of the frame 14. The platform 28 allows the user to perform a predetermined task while simultaneously operating an exercise mechanism of the exercise machine 10 such as operating the running deck 12. Such predetermined tasks may be tasks that can be executed by a control module 42. The control module 42 may include controls to adjust the speed of the conveyor belt 16, adjust a volume of a speaker integrated into the exercise machine 10, adjust an incline angle of the running deck 12, select an exercise setting, control a timer, change a view on the control module's display, monitor the user's health parameters, perform other tasks, or combinations thereof. Buttons, levers, touch screens, voice commands, or other mechanisms may be incorporated into the control panel and may be used by the user to control at least some of the functions mentioned above. The control module 42 can be used to control the functions mentioned above. Information relating to these functions may be presented to the user through the display 44. For example, a calorie count, a timer, a distance, a selected program, another type of information, or combinations thereof may be presented to the user through the display 44.

In the illustrated example, a scent diffuser 46 is built into the control module 42 and is capable of releasing a volatile. Such a volatile may include a scent that is predetermined to trigger a physiological response in the user to assist the user with his or her workout and/or recover from his or her workout. For example, the volatile may include a volatile that has a scent that has a characteristic of causing a heightened response in a user, which may give the user an additional ability or motivation to do more during the workout.

The scent diffuser 46 may include multiple types of volatiles that each have different types of scents. Each of the scents may trigger different physiological responses in the user. For example, at least one of the scents may trigger a heightened response in the user, and at least another of the volatiles may include a scent that causes the user to relax. Other types of volatiles may be included that are predetermined to trigger other types of physiological effects on the user.

In some examples, the heightened physiological effect is an induced aggression and/or alertness that provides the user an increased ability to execute his or her workout. In some examples, the volatiles that can trigger such effects in a user include volatiles with a peppermint scent, spearmint scent, another type of mint scent, a cinnamon scent, another type of scent, or combinations thereof. The physiological effects that may be induced by such a volatile scent may include increasing the user's heart rate, causing or increasing a hormone release, boosting mood, improving blood pressure, improving respiratory function, decreasing exhaustion, increasing energy, causing psychological effects, causing other physiological effects, or combinations thereof.

In some examples, the relaxed physiological effect may trigger reactions that assist the body to transition from a working out condition to a resting condition. During exercise, the user's heart rate may be elevated, the user's muscles may be experiencing a lactic acid build up, the user's muscles may ache due to other reasons, the user's blood pressure may be elevated, the user may be experiencing stress, the user may be experiencing other types of conditions, or combinations thereof. The volatiles that may assist is helping the user relax and/or reduce stress may include volatiles that contain an orange scent, a cedar scent, a lavender scent, a vanilla scent, an apple scent, a jasmine scent, a lemon scent, a cucumber scent, another type of scent, or combinations thereof. Such volatiles may assist in helping to reduce a lactic acid build up, reduce the user's stress level, reduce the user's heart rate, shorten the user's recovery period, cause other types of physiological effects, or combinations thereof.

Each user of the workout machine may have a preference for which volatiles are to be released to cause the desired physiological effect. For example, a first user may prefer to use a volatile with a peppermint scent to trigger the heightened response, but a second user may prefer to have another volatile with a cinnamon scent to trigger the heightened response. In some examples, the exercise machine 10 may include an option where a user can select the types of scents to be released for personalized workouts.

A processor may be used to determine the effect time that a particular volatile is to trigger the desired effect in the user. For example, the processor may determine that the user will begin his or her workout at noon and that the workout will last for thirty minutes. In some examples, the processor determines that the effect time of a selected volatile that causes a heightened response is noon because that is the beginning of the user's workout. Thus, the processor determines an appropriate amount of time to disperse the volatile throughout the space where the workout occurs so that the volatile can trigger the heightened response in the user at right at noon instead of releasing the volatile at noon which may result in a delayed physiological effect. The release time depends on how long the processor calculates that the selected volatile will sufficiently disperse to adequately trigger the desired affects. In some circumstances, the release time is a default time period before the effect time, such as five minutes. In other examples, each of the volatiles have customized release times. In yet other examples, the release times are altered based on environmental conditions, such as humidity, temperature, air flow, volume of the space in which the volatile is to be dispersed, other environment factors, or combinations thereof.

The effect time, such as a workout start time and/or end time, may be pre-programmed into the exercise machine 10 and/or scent diffuser 46. In other examples, the processor collects historical data, such as when the exercise machine 10 is being used to determine when the workout start and stop times. In other examples, the time effect does not necessarily correlate with the beginning and end of a workout. For example, the effect times may be based on the physiological condition of the user and/or the operating parameters of the exercise machine 10. For example, the processor may track the number of calories burned, the distance travel, the speeds ran, and so forth by the user during the workout to determine when to release a volatile with an appropriate scent to assist the user for the remainder of his or her workout.

In yet another example, the processor may track the amount of work performed by the user during the workout to determine the when to release the appropriate volatile. For example, the exercise machine 10 may be a pull cable machine and sensors incorporated into the exercise machine 10 that may track the number of pull repetitions and the amount of weight pulled. If the amount of work exceeds a predetermined threshold, the exercise machine 10 may cause a volatile with a scent to heighten the user's workout to be released. In some examples, the work threshold is low enough so that the volatile is released and has time to diffuse before the user reaches a higher work threshold where the user will likely desire the physiological effects of the scented volatiles. In some examples, the exercise machine 10 may include accelerometers that can measure vibrations induced by a user who is shaky due to pushing himself during the workout. Detection of such a shaky condition may cause the processor to determine that the effect time for releasing a specific volatile has been reached. If such a shaky condition is detected, the exercise machine 10 may cause the appropriate scent to be released to assist the user through the remainder of his or her workout. In some examples, the presence of a shaky user triggers the release of a volatile with a relaxing scent instead of a heightening scent.

In other examples, at least one physiological condition of the user is tracked during the workout. For example, the exercise machine 10 may include a heart rate monitor, a blood pressure monitor, an oxygen consumption monitor, a thermometer, a body odor detector, a surface electromyograph (EMG), an electroencephalograph, another type of physiological condition monitoring device, or combinations thereof. The processor may determine that an effect time has been reached or is likely to be forth coming based on the measurements of at least one of such monitoring devices.

For example, if the heart rate monitor indicates that the user's heart rate exceeds a specific heart rate percentage, a volatile with an appropriate scent may be released. Likewise, if the user's temperature exceeds a predetermined threshold, a volatile with an appropriate scent may be released. The body odor of the user may reflect whether the user's body is using a protein as his or her primary energy source, whether certain kinds of hormones have been released in the user's body, whether the user is experiencing a certain level of stress, whether the user is undergoing another type of condition, or combinations thereof. The odor detector may have an ability to distinguish between different types of smells and to appropriately respond to such detected conditions.

The surface EMG may include an electrode that is attached to the user's skin proximate a muscle of interest. The surface EMG may record the electrical characteristics of the muscle, which reflect the muscle's ability to perform for the duration of the workout. If the surface EMG determines that the muscle is capable of performing more work, the processor may determine to release a volatile with a heightening scent. On the other hand, if the surface EMG determines that the muscle is experiencing a lactic acid build up above a predetermined threshold, is injured, or is otherwise having difficultly, the processor may determine to release a volatile with a relaxing scent.

Multiple health related parameters may be used to determine a stress level in the user. For example, the heart rate, muscle contractions, odor detector, and/or other monitors may provide sufficient input to determine whether the user is undergoing stress. If the user is experiencing stress, the processor may cause a volatile to be released that includes a scent that counteracts the effects of the stress.

The processor may consider inputs from multiple physiological monitors to determine which type of scent to release. Such monitoring devices may be incorporated into the exercise machine 10, be located proximate the exercise machine 10, be incorporated into a wearable device by the user, be incorporated into another type of device and/or location, or combinations thereof.

In some examples, the processor may consider at least one physiological parameter in combination with an operating parameter of the exercise machine 10 to determine when to release a particular type of scent. For example, the processor may consider whether the user appears to be continuing to exercise based on the operating speed of a conveyor belt 16 of a treadmill, the movement of a crank shaft of a bicycle or elliptical, another operating condition of the exercise machine 10, or combinations thereof.

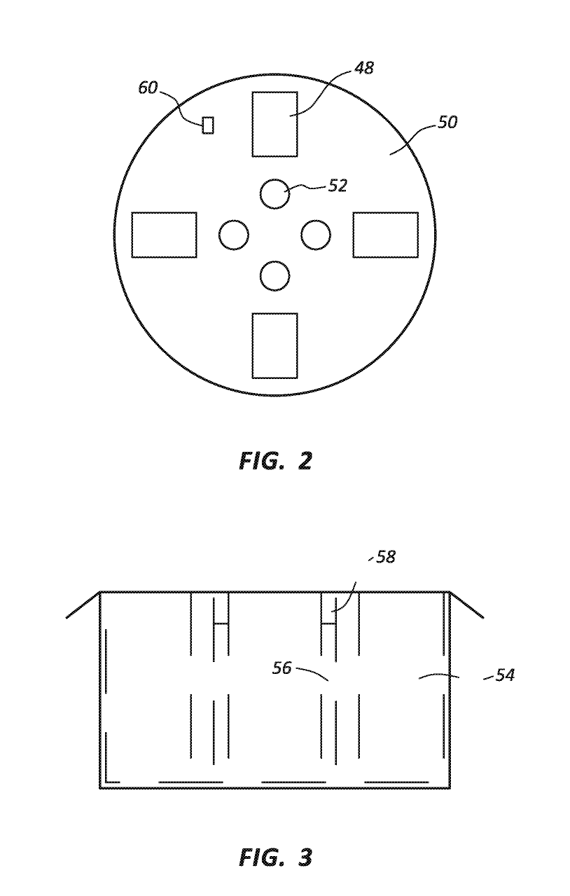

FIGS. 2 and 3 illustrates an example of a scent diffuser 46 in accordance with the present disclosure. FIG. 2 illustrates a top view of the scent diffuser 46, while FIG. 3 illustrates a side view of the scent diffuser 46. In this example, the scent diffuser 46 has multiple scent cartridges 48 that each contain a discrete amount of volatile and are secured within a diffuser body 50. Each of the cartridges 48 are in communication with an orifice 52 formed in the diffuser body 50 and selectively releases an amount of the volatile.

The scent cartridges 48 may snap into or otherwise be connected to the diffuser body 50. The scent cartridges 48 may include a chamber 54 that connects with a channel 56 that leads to the orifice 52. A valve 58 or another type of structure that can obstruct the passage of the volatile within the channel 56 prevents the volatile from being released out of the scent diffuser 46.

In some examples, each of the scent cartridges 48 contain different types of volatiles with different types of scents, while in other examples, the multiple cartridges 48 contain the same type of volatile. The processor may select one or more cartridges 48 to release the volatile at the release time. In the illustrated example, a wireless transceiver 60 is in communication with the processor and can receive commands from the processor to release a volatile from a specific cartridge. In other examples, the scent diffuser 46 is in hardwired communication with the processor. Any appropriate communication between the processor and the scent diffuser 46 may be used in accordance with the principles described in the present disclosure.

The volatile may be released with any appropriate mechanism. In some examples, the orifice 52 is closed except for the time when the scent diffuser 46 is in the process of releasing the volatile. The volatile may be released passively by opening the orifice 52 and allowing the volatile to diffuse into the ambient environment. In other examples, more active mechanisms are employed to disperse the volatile. For example, a fan may be used to force the volatile out of the cartridge at a shorter amount of time. Likewise, a heater may be used to reduce the amount of time to release the volatile. Other examples of active mechanisms may include ultrasonic vibration mechanisms, spraying mechanisms, other types of mechanism, or combinations thereof.

The active release mechanisms may enable the scent diffuser 46 to release the volatile with a shorter time lapse between the release time and the predicted effect time. Further, the characteristics of the volatile may also affect the duration between the release time and the effect time. For example, the physical state (solid, liquid, gas) of the volatile, the evaporation temperature of the volatile, the cohesion characteristics of the volatile, the surface area of the volatile, the volume of the volatile, the volume of the cartridge, the molecular weight of the volatile, the reactiveness of the volatile, the size of the orifice 52, other characteristics of the volatile, and other characteristics of the scent cartridge can be considered when determining the time span between the release time and the effect time. In some circumstances, it may be desirable to keep the time span between the release time and the effect time as short as possible to conserve the volatile.

The processor may indicate how much of the volatile to release. This may be accomplished by opening the orifice 52 for just a fractional amount of time. In other examples, the orifice 52 is opened just partially to control the amount of volatile being released. In other examples, a fan speed or a temperature is controlled to selectively release the predetermined amount of volatile. Likewise, the frequency and amplitude of the vibrations of an ultrasonic vibrator may be controlled to selectively release the desired amount of volatile.

In some examples, multiple volatiles are released at the same time to effect a single or multiple physiological effects on the user. In other examples, a single type of volatile is release at a time.

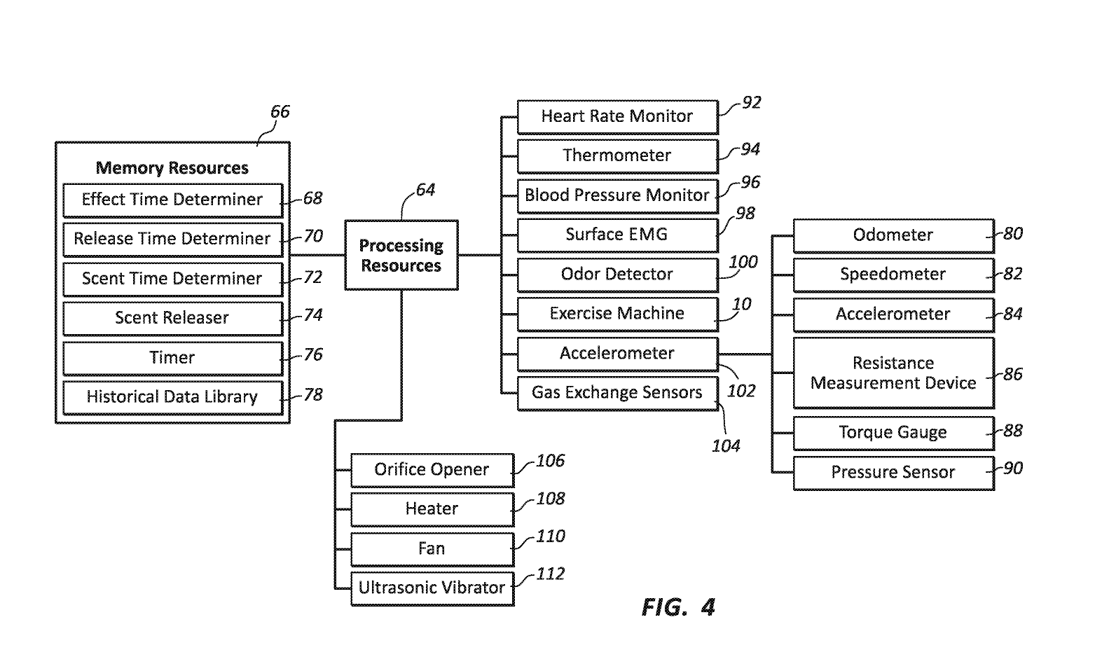

FIG. 4 illustrates a block diagram of an example of a physiological control system 62 in accordance with the present disclosure. The physiological control system 62 may include a combination of hardware and program instructions for executing the functions of the physiological control system 62. In this example, the physiological control system 62 includes processing resources 64 that are in communication with memory resources 66. Processing resources 64 include at least one processor and other resources used to process programmed instructions. The memory resources 66 represent generally any memory capable of storing data such as programmed instructions or data structures used by the physiological control system 62. The programmed instructions shown stored in the memory resources 66 include an effect time determiner 68, a release time determiner 70, a scent type determiner 72, a scent releaser 74, and a timer 76. The data structures shown stored in the memory resources 66 include a historical data library 78.

The memory resources 66 include a computer readable storage medium that contains computer readable program code to cause tasks to be executed by the processing resources 64. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The effect time determiner 68 represents programmed instructions that, when executed, cause the processing resources 64 to determine the time that the physiological effect of the volatile is desirable. The effect time may be pre-programmed into the memory resources 66. In other examples, the effect time is determined based on historical data from the historical data library 78. Such historical data may be used to determine when a user starts his or her workout, ends his or her workout, other types of information, or combinations thereof. In yet other examples, the effect time is determined based on an operating parameter of the exercise machine 10. The exercise machine 10 may be equipped with an odometer 80, a speedometer 82, an accelerometer 84, a resistance measurement device 86, a torque gauge 88, a pressure sensor 90, another type of monitor that can measure an operating parameter of the exercise machine 10, or combinations thereof. Additionally, the effect time may be determined based on a physiological measurement of the user. In such examples, monitors that are worn by the user, incorporated into the exercise machine 10, or positioned nearby the exercise machine 10 that are capable of measuring a physiological parameter of the user may include a heart rate monitor 92, a thermometer 94, a blood pressure monitor 96, a surface EMG 98, an odor detector 100, a wearable accelerometer 102, a gas exchange sensor 104 such as an oxygen consumption monitor, another type of monitor, or combinations thereof. In some examples, a combinations of monitors provide input that is available to the effect time determiner 68. For example, sensors monitoring the user, sensors monitoring the exercise machine 10, and/or pre-programmed instructions may be used together to determine the effect time.

The release time determiner 70 represents programmed instructions that, when executed, cause the processing resources 64 to determine the time to release the volatile so that the volatile causes the desired physiological effect on the user at the effect time. In some instances, a sensor determines that the user is already in a condition where the physiological effect is desirable. In such circumstances, the release time may be determined to be immediate. In such situations where the volatile is released immediately in response to detecting a desire to have the physiological effect implemented, the effect time and the release time may coincide.

The scent type determiner 72 represents programmed instructions that, when executed, cause the processing resources 64 to determine the type of volatile to release to the user. In some situations, the type of desired physiological effect is the single factor for determining which volatile to release. In other examples where multiple users have access to the exercise machine 10, the identity of the user may also be a factor. For example, a first user may prefer to have a peppermint scent to provide him or her with a heightened physiological response, while a second user may prefer to have a cinnamon scent to cause the heightened physiological response. In such situations, the user's identity may be inputted into the exercise machine 10 or recognized by the exercise machine 10.

The scent releaser 74 represents programmed instructions that, when executed, cause the processing resources 64 to send a command to the scent diffuser 46 to release the appropriate volatile. In some examples, the scent releaser 74 sends the command to an orifice opener 106, a heater 108, a fan 110, an ultrasonic vibrator 112, another type of device, or combinations thereof. The timer 76 represents programmed instructions that, when executed, cause the processing resources 64 to enable the scent releaser 74 to release the volatile at the appropriate time.

Further, the memory resources 66 may be part of an installation package. In response to installing the installation package, the programmed instructions of the memory resources 66 may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources 66 can include integrated memory such as a hard drive, a solid state hard drive, or the like.

In some examples, the processing resources 64 and the memory resources 66 are located within the scent diffuser 46 and/or the exercise machine 10. The memory resources 66 may be part of the scent diffuser's and/or the exercise machine's main memory, caches, registers, non-volatile memory, or elsewhere in the scent diffuser's and/or the exercise machine's memory hierarchy. Alternatively, the memory resources 66 may be in communication with the processing resources 64 over a network. Further, the data structures, such as the libraries, may be accessed from a remote location over a network connection while the programmed instructions are located locally. Thus, the physiological control system 62 may be implemented on the scent diffuser 46, the exercise machine 10, a user device, a mobile device, a phone, an electronic tablet, a wearable computing device, a head mounted device, a server, a collection of servers, a networked device, a watch, or combinations thereof. Such an implementation may occur through input mechanisms, such as push buttons, touch screen buttons, voice commands, dials, levers, other types of input mechanisms, or combinations thereof.

The physiological control system 62 of FIG. 4 may be part of a general purpose computer. However, in alternative examples, the physiological control system 62 is part of an application specific integrated circuit.

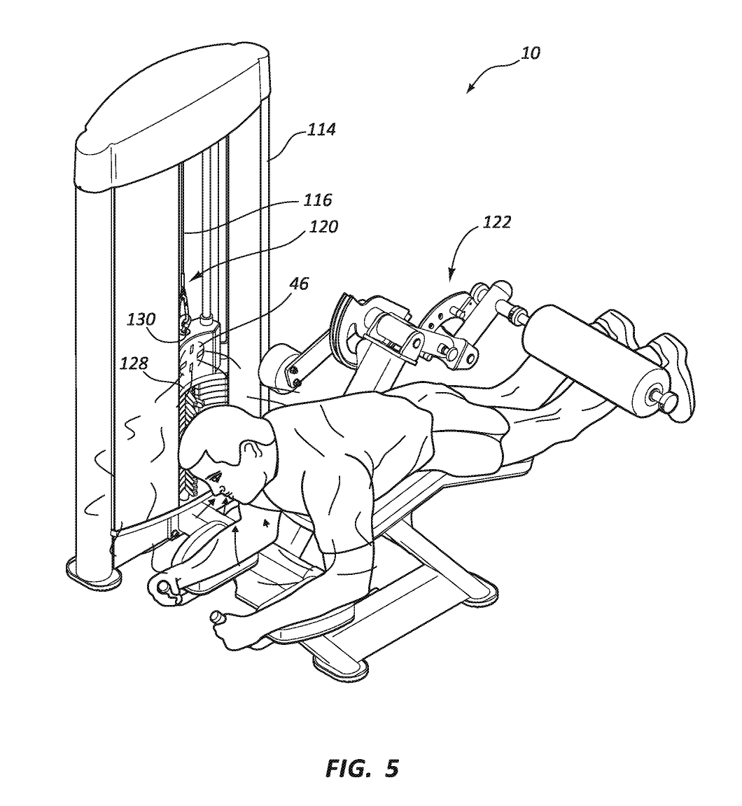

FIG. 5 illustrates a perspective view of an example of an exercise machine 10 with a scent diffuser 46 in accordance with the present disclosure. The exercise machine 10 is a cable exercise machine with a frame 114 that supports a cable 116. A weight assembly 118 is attached to a lifting end 120 of the cable 116 and a pulling attachment 122 is connected to a pull end of the cable 116. The cable 116 is supported with at least one pulley that causes the pull forces exerted by the user on the pull end of the cable 116 to raise the lifting end 120 of the cable 116. The weight assembly 118 may include multiple weight plates 128 that are arranged to be lifted with the lifting end 120 of the cable 116 when interlocked with a lifting member 130 connected to the lifting end 120.

The scent diffuser 46 may be incorporated into the exercise machine 10 illustrated in FIG. 5. The operating parameters of the exercise machine 10 may be measured to determine when a physiological effect of the user is desirable. For example, the sensors may measure the amount of work performed by the user, the amount of weight lifted by the user, the number of lifts performed by the user, the rate at which the user is performing the lifts, the speed of the lifts, whether the lifts appear to take an increased amount of time to execute, the steadiness of the lifts, other parameters of the exercise machine, or combinations thereof.

While the above examples have been described as being incorporated into a specific type of cable exercise machine and a treadmill, the principles herein may be incorporated into any appropriate type of exercise machine or exercise accessory. For example, other types of cable exercise machines that may incorporate the principles described herein include cable exercise machines that allow a user to do exercises that work latissimus dorsi muscles, pectoral muscles, bicep muscles, tricep muscles, deltoid muscles, trapezius muscles, other muscles, and combinations thereof. Further, the scent diffuser 46 may be integrated into a pull-up bar, workout bench, a weight stack structure, a dumb bell, an elliptical, a stationary bike, a self-propelling bike, a stepper machine, a skiing machine, a rowing machine, a squat machine, another type of exercise accessory and/or machine, or combinations thereof.

Further, while the examples above have been described with reference to specific types of scent diffusers, any appropriate type of scent diffuser 46 may be used in accordance with the principles described herein. For example, the scent diffuser may include a mechanism, such as a tube, that brings the volatile proximate the user's face. In such examples, a smaller amount of volatile may be released to achieve the desirable effect. In yet other examples, the scent diffuser is incorporated into the user's clothing. In such examples, the user may benefit from the principles described herein in an outdoor setting.

The scent diffuser may be positioned near the user's face while being incorporated into the user's clothing to achieve the desired physiological effect. For example, a scent cartridge may be sized to be positioned in a pocket of an exercise jacket worn by the user. A tube may be connected to the cartridge on a first end of the tube and clipped to the collar of the jacket. A heart rate monitor and/or another type of sensor in the user's watch or other mobile device may send commands to the scent diffuser during the workout to release a particular scent. In response to the commands, the scent diffuser may release the volatile into the first end of the tube. The volatile may be released out the second end of the tube proximate the user's face to cause the predetermined physiological effect.

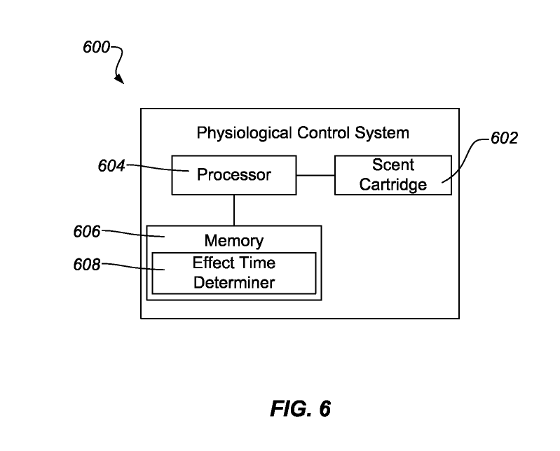

FIG. 6 depicts a physiological control system 600 with at least one scent cartridge 602 that selectively releases a volatile that exhibits a characteristic that causes a predetermined physiological effect on a user in response to a release command from a processor 604. The processor 604 is in communication with memory 606 that contains an effect time determiner 608 associated with a user workout to cause the predetermined physiological effect. The processor 604 sends the release command to scent cartridge 602 based on the effect time.

### INDUSTRIAL APPLICABILITY

In general, the invention disclosed herein may provide a user a desirable physiological effect that can enhance the user's workout, improve the user's recovery from a workout, relax the user, or provide another desirable physiological effect. Such physiological effects may improve the user's health as a result of an improved workout and/or recovery.

For example, a physiological control system may include a scent cartridge that selectively releases a volatile that exhibits a characteristic that causes a predetermined physiological effect on a user. The volatile may be released in response to a release command from a processor that is in communication with the scent cartridge. The processor may also be in communication with memory that contains programmed instructions to cause the processor to determine a desired effect time, which may be the time that it would be desirable for the physiological effect to occur in the user. Such an effect time may be associated with a user workout. For instance, it may be desirable for the physiological effect to occur at the end of a workout, at the beginning of a workout, during the workout, at a specific time during the workout, at another time, or combinations thereof. In one example, it may be desirable to release a volatile that causes a user to relax after the completion of the user's workout. In another example, it may desirable to release a volatile that energizes the user shortly after the beginning of the workout. The effect time can be specific to the type of volatile and the goals of the user. As such, the user may customize the system to release the desired volatile at the time that the user desired.

However, the volatile may need to be released into the environment surrounding the user at a time prior to the predetermined effect time. For example, it may take several minutes or more in some instances for the volatile to cause the predetermined effect after being released. As such, the release time may be determined to be a specific time duration before the predetermined effect time. A processor may send the release command to the scent cartridge based on the effect time and the associated time delay specific for the particular volatile being release. In some examples, the volatile may immediately cause the predetermined effect on the user upon release. In other examples, the volatile may need to be released a significant time period before the predetermined effect time.

The scent diffuser can be incorporated into any appropriate type of exercise machine, exercise device, exercise clothing, or combinations thereof. Further, the physiological effect can be achieved in both indoor and outdoor settings. Exercise devices/machines that are shared among multiple users can include logic that allows the exercise device/machine to identify the person currently executing the workout and customize the effect times, the release times, the type of volatile, and other parameters specific to each of the users.

The scent diffuser may include multiple scent cartridges that each contain a discrete amount of volatile and are secured within a diffuser body. Each of the cartridges are in communication with an orifice formed in the diffuser body and selectively releases an amount of the volatile. For example, the scent cartridges may snap into or otherwise be connected to the diffuser body. The scent cartridges may include a chamber that connects with a channel that leads to the orifice. A valve or another type of structure that can obstruct the passage of the volatile within the channel prevents the volatile from being released out of the scent diffuser.

In some examples, each of the scent cartridges contain different types of volatiles with different types of scents, while in other examples, the multiple cartridges contain the same type of volatile. The processor may select one or more cartridges to release the volatile at the release time. In the illustrated example, a wireless transceiver is in communication with the processor and can receive commands from the processor to release a volatile from a specific cartridge. In other examples, the scent diffuser is in hardwired communication with the processor. Any appropriate communication between the processor and the scent diffuser may be used in accordance with the principles described in the present disclosure.

The volatile may be released with any appropriate mechanism. In some examples, the orifice is closed except for the time when the scent diffuser is in the process of releasing the volatile. The volatile may be released passively by opening the orifice and allowing the volatile to diffuse into the ambient environment. In other examples, more active mechanisms are employed to disperse the volatile. For example, a fan may be used to force the volatile out of the cartridge at a shorter amount of time. Likewise, a heater may be used to reduce the amount of time to release the volatile. Other examples of active mechanisms may include ultrasonic vibration mechanisms, spraying mechanisms, other types of mechanism, or combinations thereof.

The active release mechanisms may enable the scent diffuser to release the volatile with a shorter time lapse between the release time and the predicted effect time. Further, the characteristics of the volatile may also affect the duration between the release time and the effect time. For example, the physical state (solid, liquid, gas) of the volatile, the evaporation temperature of the volatile, the cohesion characteristics of the volatile, the surface area of the volatile, the volume of the volatile, the volume of the cartridge, the molecular weight of the volatile, the reactiveness of the volatile, the size of the orifice, other characteristics of the volatile, and other characteristics of the scent cartridge can be considered when determining the time span between the release time and the effect time. In some circumstances, it may be desirable to keep the time span between the release time and the effect time as short as possible to conserve the volatile.

The processor may indicate how much of the volatile to release. This may be accomplish by opening the orifice for just a fractional amount of time. In other examples, the orifice is opened just partially to control the amount of volatile being released. In other examples, a fan speed or a temperature is controlled to selectively release the predetermined amount of volatile. Likewise, the frequency and amplitude of the vibrations of an ultrasonic vibrator may be controlled to selectively release the desired amount of volatile.

In some examples, multiple volatiles are released at the same time to effect a single or multiple physiological effects on the user. In other examples, a single type of volatile is release at a time.

The volatiles can be released at the beginning of a workout, the end of the workout, and/or during the workout as determined. Further, the amount of volatile can be conserved by purposefully releasing the volatile with a short time span between the determine effect time and the release time.

The physiological control system may have one or more scent cartridges that selectively release at least one volatile into a space surrounding an exercise machine. The volatile may exhibit a characteristic that causes a predetermined physiological effect on a user. In some cases, multiple volatiles are released together to collectively cause a predetermined effect. In yet other examples, multiple volatiles that exhibit characteristics of independently predetermined responses are released.

A processor is in communication with memory where the memory contained programmed instructions to determine an effect time associated with a user workout to cause the predetermined physiological effect. The processor sends the release command to scent cartridge or cartridges based on the effect time. The programmed instructions may cause the processor to determine a release time prior to the effect time that allows the volatile to diffuse within the space prior to the effect time. In some circumstances, the processor is in communication with the exercise machine directly. In other circumstances, the processor is incorporated into the exercise machine. In yet other examples, the processor is in indirect communication with the exercise machine, such as through a mobile device, a network device, another type of device, or combinations thereof.

In some cases, the effect time and/or release time is determined in part based on the operating parameters of the exercise machine. Further, the effect time and/or release time may be determined in part based on the physiological parameters measured from the user. Factors to determine the effect time may include historical behavior of the user, a heart rate, lactic acid build up, a user temperature, a stress level, the end time of the workout, a predetermined initiation time of the user's workout, or combinations thereof. For instance, in circumstances where the processor determines that the user is getting sluggish in his or her workout, the processor may determine that the effect time for the user to have the physiological effect is forth coming. In such an instance, the processor may calculate a release time to release the volatile and execute the release based on the release time.

The processor may also determine the effect time based on the historical behavior of the user. For example, the processor may determine that the user exercises on a consistent schedule across multiple days, on just certain days of the week, or according to another pattern. In those instances that it is determined that the user consistently starts his or her workout at 8:00 am, the processor may determine that the predetermined effect time to cause the physiological effect of generating a heighten response in the user is right at 8:00 am. In such an example, the processor may determine that the release time should be 7:45 am or another time prior to 8:00 am so that the volatile is sufficiently dispersed throughout the room where the workout is to occur.

In another example, the historical behavior of the user may determine that the user completes his or her workout at 8:45 am. In such an example, the processor may determine that a volatile with the physiological effect of relaxing the user is 8:45 am. In such an example, the processor may determine that the release time of the appropriate volatile is prior to 8:45 am. In some examples, the release time and the predetermined effect time may be the same time. However, in other examples, the release time may be determined to be a specific time duration prior to the predetermined effect time.

A processor may be used to determine the effect time that a particular volatile is to trigger the desired effect in the user. For example, the processor may determine that the user will begin his or her workout at noon and that the workout will last for thirty minutes. In some examples, the processor determines that the effect time of a selected volatile that causes a heightened response is noon because that is the beginning of the user's workout. Thus, the processor determines an appropriate amount of time to disperse the volatile throughout the space where the workout occurs so that the volatile can trigger the heightened response in the user at right at noon instead of releasing the volatile at noon which may result in a delayed physiological effect. The release time depends on how long the processor calculates that the selected volatile will sufficiently disperse to adequately trigger the desired affects. In some circumstances, the release time is a default time period before the effect time, such as five minutes. In other examples, each of the volatiles have customized release times. In yet other examples, the release times are altered based on environmental conditions, such as humidity, temperature, air flow, volume of the space in which the volatile is to be dispersed, other environment factors, or combinations thereof.

In yet another example, the processor may track the amount of work performed by the user during the workout to determine the when to release the appropriate volatile. For example, the exercise machine may be a pull cable machine and sensors incorporated into the exercise machine that may track the number of pull repetitions and the amount of weight pulled. If the amount of work exceeds a predetermined threshold, the exercise machine may cause a volatile with a scent to heighten the user's workout to be released. In some examples, the work threshold is low enough so that the volatile is released and has time to diffuse before the user reaches a higher work threshold where the user will likely desire the physiological effects of the scented volatiles. In some examples, the exercise machine may include accelerometers that can measure vibrations induced by a user who is shaky due to pushing himself during the workout. Detection of such a shaky condition may cause the processor to determine that the effect time for releasing a specific volatile has been reached. If such a shaky condition is detected, the exercise machine may cause the appropriate scent to be released to assist the user through the remainder of his or her workout. In some examples, the presence of a shaky user triggers the release of a volatile with a relaxing scent instead of a heightening scent.

In other examples, at least one physiological condition of the user is tracked during the workout. For example, the exercise machine may include a heart rate monitor, a blood pressure monitor, an oxygen consumption monitor, a thermometer, a body odor detector, a surface electromyograph (EMG), an electroencephalograph, another type of physiological condition monitoring device, or combinations thereof. The processor may determine that an effect time has been reached or is likely to be forth coming based on the measurements of at least one of such monitoring devices.

The surface EMG may include an electrode that is attached to the user's skin proximate a muscle of interest. The surface EMG may record the electrical characteristics of the muscle, which reflect the muscle's ability to perform for the duration of the workout. If the surface EMG determines that the muscle is capable of performing more work, the processor may determine to release a volatile with a heightening scent. On the other hand, if the surface EMG determines that the muscle is experiencing a lactic acid build up above a predetermined threshold, is injured, or is otherwise having difficultly, the processor may determine to release a volatile with a relaxing scent.

Multiple health related parameters may be used to determine a stress level in the user. For example, the heart rate, muscle contractions, odor detector, and/or other monitors may provide sufficient input to determine whether the user is undergoing stress. If the user is experiencing stress, the processor may cause a volatile to be released that includes a scent that counteracts the effects of the stress.

What is claimed is:

1. A physiological control system, comprising:
a processor;
at least one scent cartridge in communication with the processor, wherein the scent cartridge selectively releases a volatile that causes a predetermined physiological effect on a user in response to a release command from the processor; and
a memory in communication with the processor, wherein the memory contains programmed instructions that, when accessed by the processor, cause the processor to determine an effect time associated with a user workout to cause the predetermined physiological effect;
wherein the processor sends the release command to the at least one scent cartridge based on the effect time.

2. The physiological control system of claim 1, wherein the memory further contains programmed instruction to cause the processor to determine a release time prior to the effect time that allows the volatile to diffuse within the space prior to the effect time.

3. The physiological control system of claim 1, wherein the processor is in communication with an exercise machine.

4. The physiological control system of claim 3, wherein the processor is programmed to obtain operating parameters of the exercise machine to determine the effect time.

5. The physiological control system of claim 1, wherein the processor is programmed to determine the effect time based at least in part on a pre-programmed time.

6. The physiological control system of claim 1, wherein the processor is programmed to determine the effect time based at least in part on historical behavioral data of the user.

7. The physiological control system of claim 1, wherein the processor is programmed to determine the effect time based at least in part on a direct measurement of a physiological parameter of the user.

8. The physiological control system of claim 7, wherein the physiological parameter comprises a heart rate.

9. The physiological control system of claim 7, wherein the physiological parameter comprises a lactic acid build up.

10. The physiological control system of claim 7, wherein the physiological parameter comprises a temperature.

11. The physiological control system of claim 7, wherein the physiological parameter comprises a stress level.

12. The physiological control system of claim 1, wherein the effect time comprises a predetermined end time of the user workout.

13. The physiological control system of claim 1, wherein the effect time comprises a predetermined initiation time of the user workout.

14. The physiological control system of claim 1, wherein the predetermined physiological effect includes inducing a heightened response in the user.

15. The physiological control system of claim 1, wherein the predetermined physiological effect includes inducing a relaxing response in the user.

16. The physiological control system of claim 1, wherein the at least one scent cartridge is attached to an exercise machine.

17. A physiological control system, comprising:
a processor;
at least one scent cartridge in communication with the processor, wherein the scent cartridge selectively releases a volatile that causes a predetermined physiological effect on a user in response to a release command from the processor; and
a memory in communication with the processor, wherein the memory contains programmed instructions, which when accessed by the processor, cause the processor to determine an effect time associated with a user workout to cause the predetermined physiological effect;
wherein the processor is in communication with an exercise machine and is programmed to obtain operating parameters of the exercise machine to determine the effect time; and
wherein the processor sends the release command to the at least one scent cartridge based on the effect time.

18. The physiological control system of claim 17, wherein the predetermined physiological effect includes inducing a heightened response or a relaxing response in the user.

19. The physiological control system of claim 17, wherein the processor is programmed to determine the effect time based at least in part on a direct measurement of a physiological parameter of the user.

20. A physiological control system, comprising:
a processor;
at least one scent cartridge that selective releases a volatile into a space with an exercise machine in response to a command from the processor, the volatile exhibiting a characteristics that causes a predetermined physiological effect on a user;
a memory communicatively coupled to the processor, wherein the memory contains programmed instructions that, when accessed by the processor, cause the processor to determine an effect time associated with a user workout to cause the predetermined physiological effect where the processor is programmed to determine the effect time based at least in part on a direct measurement of a physiological parameter of the user;
wherein the processor is in communication with an exercise machine and is programmed to obtain operating parameters of the exercise machine to determine the effect time;
wherein the predetermined physiological effect includes inducing a heightened response or a relaxing response in the user; and
wherein the processor sends the release command to the at least one scent cartridge based on the effect time.
